(19) United States
(12) Patent Application Publication
(10) Pub. No.: US 2011/0041707 A1
(43) Pub. Date: Feb. 24, 2011

(54) Wok Water Saver Table

(76) Inventor: Hector Delgadillo, Pasadena, CA (US)

Correspondence Address: STEVEN A. NIELSEN;ALLMAN & NIELSEN, P.C., 100 Larkspur Landing Circle, Suite 212, LARKSPUR, CA, 94939, US

(21) Appl. No.: 12/825,056

(22) Filed: Jun. 28, 2010

Related U.S. Application Data
(60) Provisional application No. 61/235,629, filed on Aug. 20, 2009.
(60) Provisional application No. 61/235,621, filed on Aug. 20, 2009.

(51) Int. Cl. A47J 37/10

(52) U.S. Cl. 99/422

(57) ABSTRACT

A circular wok support structure 112, constructed in the shape of a hollow cylinder, with a bottom end adjacent to a wok burner assembly 605 and a top end located above an upper deck plate 111, is used as an inner circular wall area within a surface cooling tank 300 to cool a wok table. The surface cooling tank 300 circulates cooling water or fluid within a closed system and transfers wok heat and wok burner heat by use of a wok table top or upper deck plate 111 integrated as a top wall to the surface cooling tank 300. A wok burner assembly 605 is centered under the wok support structure 112 allowing the wok support structure 112 to directly transfer both wok heat and wok burner heat into the surface cooling tank 300.

### CROSS-REFERENCE TO RELATED APPLICATIONS

### Incorporation by Reference

This application claims the priority date, contents and benefit of U.S. patent application 61/235,629 entitled Dipper Well Water System filed on Aug. 20, 2009 as well as patent application 61/235,621 entitled Wok Gas Shut Off Valve filed on Aug. 20, 2010, the contents of the related patent applications are incorporated herein by reference as if restated in their entirety.

### BACKGROUND OF THE INVENTION

(1) Field of the Invention

The invention generally relates to closed liquid cooling systems. More particularly, the invention relates to means and methods efficiently cooling cooking implements such as wok tables with minimum water consumption.

(2) Description of the Related Art

In the known related art, wok tables used in commercial settings are liquid cooled in open systems that consume an average of 6,000 gallons of water per day. The related art has failed to adapt to the growing scarcity of water and fails to comport with new guidelines for the conservation of water. Thus, there is room in the art as well as a real world need for means and methods of cooling wok tables and other cooking tools in a manner that recycles water or cooling fluid.

In the related art wok tables are often cooled by the passing of water over the table top on a one time basis wherein the water passes out of the kitchen and into a storm drain or sanitary sewer line. Moreover, passing water over the top of the wok table is largely ineffective in preventing burn injuries as wok cooks sometimes place their hands upon the table top and literally “cook” their hands. In a cooking presentation setting, customers are at risk for burn injuries when the traditional wok table is used. Furthermore, the heat used to operate the one or two customary woks will bend, melt or otherwise damage the wok table if a cooling system is not in operation.

### BRIEF SUMMARY OF THE INVENTION

The present invention overcomes shortfalls in the related art by presenting an unobvious and unique combination and configuration of components to construct a self-contained wok table and wok table cooling system. The present invention overcomes shortfalls in the related art by conserving vast amounts of water and by greatly increasing worker safety.

During normal operation of one embodiment of the invention, a surface cooling tank contains circulating water or other cooling fluid. The surface cooling tank is defined by several metal walls, many of which are in direct contact with heat generated by the wok burner assembly and/or the wok. The upper wall of the surface cooling tank comprises the table top or upper deck plate, a surface that is frequently touched by a cook using one or two woks heated within the wok table.

The wok burner assembly is located well below the upper deck plate and surface cooling tank. A wok support structure is formed in a tube shape, supports a wok and runs from the burner assembly to an area well above the upper deck plate. Excellent thermal exchange or table top cooling is achieved by a section of the wok support structure forming circular interior walls within the cooling tank. Thus, the cooling tank is integrated with the wok support structure, resulting a direct and efficient transfer of unwanted and dangerous heat away from the table top and wok cook.

Water or cooling fluid removes heat or thermal energy from the wok table and transfers the heat to an external water cooler or refrigeration unit. Unlike wok tables in the related art, no water is consumed in the cooling process and the wok table does not become hot enough to pose a risk of injury to the wok cook or surrounding bystanders.

In the event of a cooling failure, the disclosed system reverts to a traditional method of cooling wherein water runs over a back waterfall board, runs over the table top and then drains out to a storm drain or sanitary sewer line.

Unlike the related art, the present invention includes means and methods of cooling wok tables and other items by supportive means allowing for cooking and other food preparation in a temperature safe environment.

The present invention includes means and methods of creating new cooling assemblies that feature automatic cooling faucets triggered by photocells, above sink cooling, inter tank cooling, voids for woks, and other features.

These and other objects and advantages will be made apparent when considering the following detailed specification when taken in conjunction with the drawings.

### BRIEF DESCRIPTION OF THE DRAWINGS

FIG. 1 is a front perspective view of one embodiment of the invention

FIG. 2 is a front sectional view of one embodiment of the invention

FIG. 3 is a rear perspective view of one embodiment of the invention

FIG. 4 is a plan view of the top section of one embodiment of the invention

FIG. 5A is a perspective view of a lower box assembly

FIG. 5B is a close up view of the right hand side of the lower box assembly of FIG. 5A

FIG. 6 is a side sectional view of one embodiment of the invention

FIG. 7 is a perspective view of several pipe and burner components found in one embodiment of the invention.

FIG. 8 shows an alternative retro fit unit for use with existing gas wok assemblies

FIG. 9 shows a retro fit top surface

### REFERENCE NUMERALS IN THE DRAWINGS

100 one embodiment of the invention in general
110 a waterfall backstop used to direct the waterfall to the upper deck plate 111
111 an upper deck plate used to convey water from the waterfall backstop to the upper water collection pool area 117
112 a wok support structure located on top of the upper deck plate 111
113 a side cabinet cover
114 a waterfall disperser component
115 a mid-waterway for directing water from the upper deck plate to the lower collection pool 118
116 a water faucet used for the supply of cooking water and other uses
117 an upper water collection pool area that accepts water from the upper deck plate 111 and directs water through the mid-waterway 115
118 a side cover securing the upper deck plate 111 to the waterfall backstop 110
119 a filter for trapping food stuffs and other debris
120 voids defined by the wok support structure 112, a wok may fit into the void 120 and be retained by the wok support structure
121 a drain
122 a lower waste tank or water collection pool
123 a faucet water time control button
200 a water supply line to the water faucet 116
201 a water supply line to the waterfall disperser component 114 or waterfall header 600
202 an inlet for accepting chilled water
203 an outlet for draining water back to a cooling unit
300 surface cooling tank, cools upper deck plate 111
301 angled front wall of surface cooling tank 300
302 back wall of surface cooling tank 300
303 side wall of surface cooling tank 300
304 bottom wall of surface cooling tank 300
400 one embodiment of a lower box assembly
401 a thermo couple
402 a waterfall sensor valve
403 a faucet solenoid valve
405 a faucet water time control button
406 a voltage transformer
407 a waterfall safety thermostat
408 a rocker on/off switch for controlling fuel to the burners
409 tube to thermo couple 401
410 plug for electrical input
600 a waterfall header
601 a water anti-hammer device
602 a water inlet
605 a wok burner assembly
606 a natural gas inlet
607 a gas header supplying gas to the wok burner assemblies 605
608 main water valve
609 pilot flame adjuster
610 gas adjustment lever
611 a fluid and gas line assembly
612 waterfall and faucet junction
700 a retro fit assembly used with existing wok burner assemblies
701 a retro fit top cooling assembly or table wok cooling tank used to surround woks with cool fluid
750 a cooling unit used to cool fluid supplied to a wok cooling unit

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

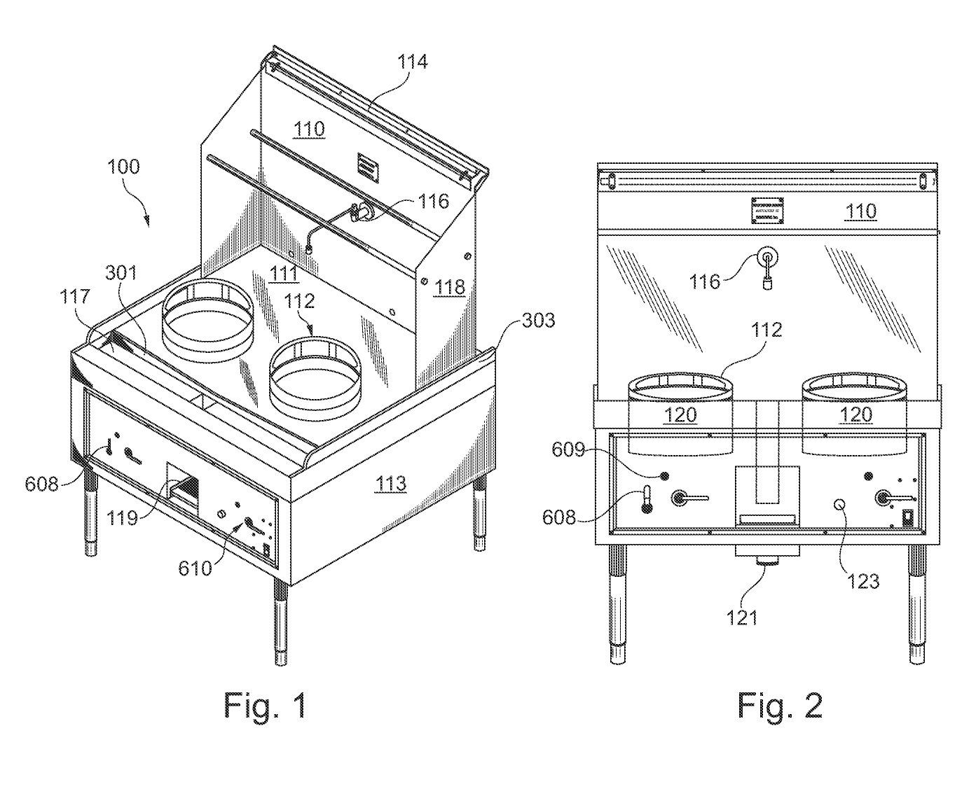

Referring to FIG. 1, one embodiment of the invention 100 is shown in a front perspective view with the front side in the foreground and backside in the background. An upper deck plate 111 or table top surface is exposed and is cooled with cooling fluid, such as water that circulates below the upper deck plate. Attached to the upper deck plate is a wok support structure 112 which is circular and accepts a wok or other cooking vessel. The front section of the disclosed structure comprises a gas adjustment lever 610, a pilot flame adjuster 609, and a filter 119 for trapping food stuffs and other debris.

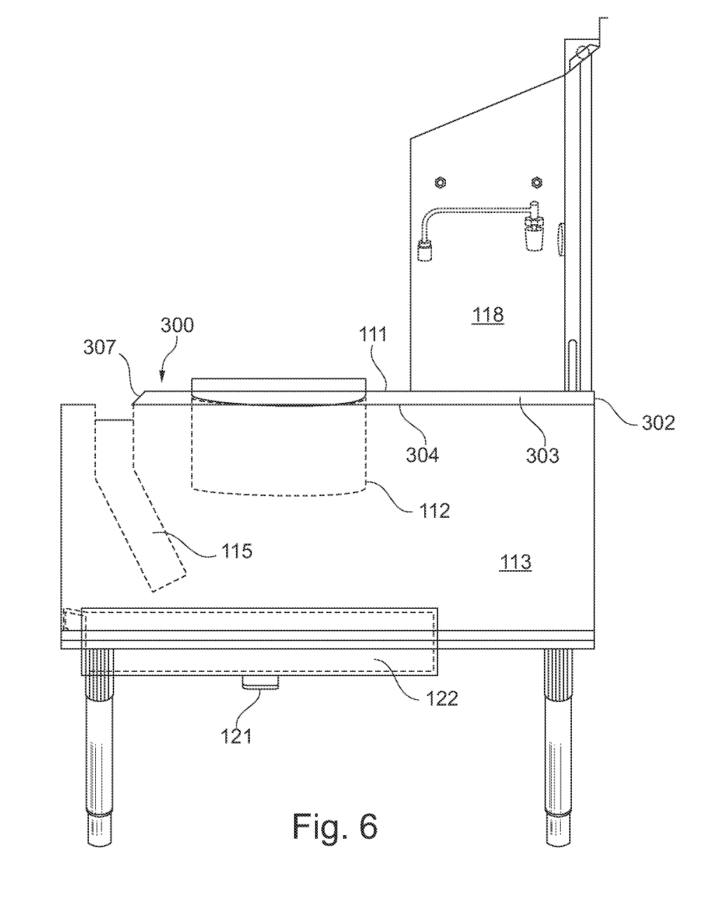

In the event of a water cooling system failure, non-circulating water flows from the waterfall disperser component 114, down the waterfall backstop 110, over the top of the upper deck plate 111, down the angled front wall 301, into the upper water collection pool area 117, through the filter 119, through the mid-waterway 115 (FIG. 6), into the lower waste tank 122 and out through the drain 121.

Referring back to FIG. 1, a side cover 118 secures the upper deck plate to the waterfall backstop 110. A side cabinet cover 113 protects the inside components of the machine.

Referring to FIG. 2, a front sectional view presents the water faucet 116 which is attached to the waterfall backstop 110. A water faucet activation button 123 allows water to flow from the water faucet 116 in intervals of 10 to 20 seconds, allowing an operator of the disclosed system to add water to a wok or other cooking vessel. As water from the water faucet 116 is not recycled within the disclosed system, having a timed allowance of water from the water faucet is an important water saving feature.

During normal use, an operator places a wok within a void 120 defined by the circular wok support structure 112 which extends above the upper deck plate 111. Due to the high levels of heat needed for wok cooking, the upper deck plate 111 can become dangerous heat hazard to the operator or cook.

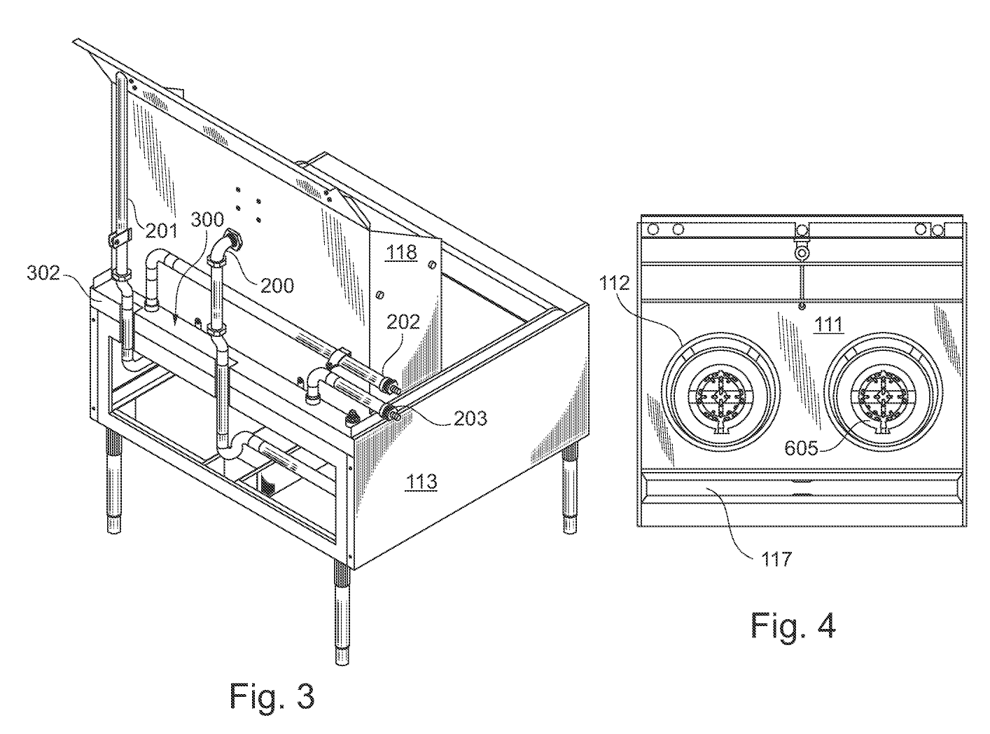

Referring to FIG. 3, a back perspective view presents various plumbing components such as a water supply line 200 to the water faucet 116, and inlet pipe 202 for accepting cooled water, an outlet pipe 203 for returning water to a cooling device, and a water supply line 201 leading to the waterfall disperser component. The supply of water or other coolant to the inlet pipe 202 is cooled by use of an external refrigeration device or other cooling device. After cooled water circulates within the surface cooling tank 300, the water gains heat generated by the burner assembly 605, of FIG. 4, the heated water then exits the surface cooling tank 300 through the outlet pipe 203, wherein the heated water is directed back into an external cooler, not shown.

Referring to FIG. 4, a plan view of the burner assemblies 605 are shown within the center of the wok support structures 112.

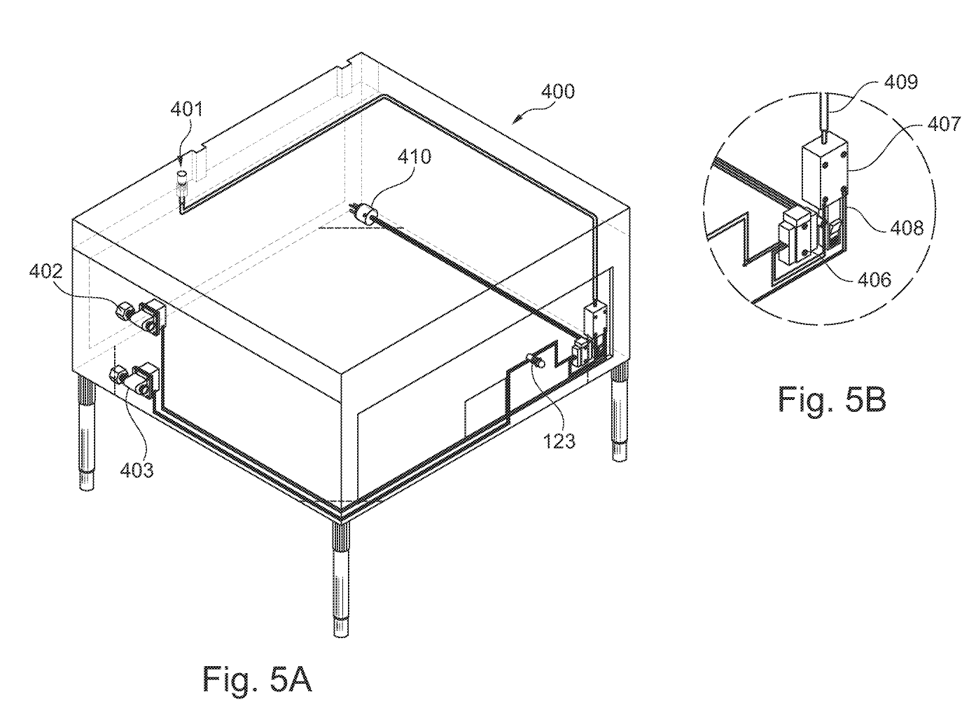

Referring to FIG. 5A, a lower box assembly is shown to highlight the certain electronic components of the disclosed system. A faucet water time control button 123 provides a timed release of water through the water faucet in order to minimize water waste. A thermo couple monitors the temperature of the wok table. A water fail sensor valve 402 and a faucet solenoid valve 403 provide control for a backup system that directs fresh water or tap water over the waterfall backstop, over the upper deck plate and eventually to the drain 121 in the event of a system failure. An electrical plug 410 is used to supply power to the system.

FIG. 5B presents an expanded view of the right hand side of FIG. 5A and presents a tube to thermo couple 401, a waterfall safety thermostat 407, a rocker on/off switch 408 for controlling fuel levels to the burner assembly, and a voltage transformer 406.

FIG. 6 presents a side sectional view that features various enclosure sides and enclosure surfaces of the surface cooling tank 300 which is an enclosure defined by the upper deck plate 111, an angled front wall 301, a bottom wall 304, a back wall 302 and two side walls 303. FIG. 6 shows that certain sections of the wok support structure 112 form additional circle shaped internal walls within the surface cooling tank 300. Cooled fluid circulating within the surface cooling tank removes heat from the wok support structure, as well as the other components that define the walls of the surface cooling tank 300.

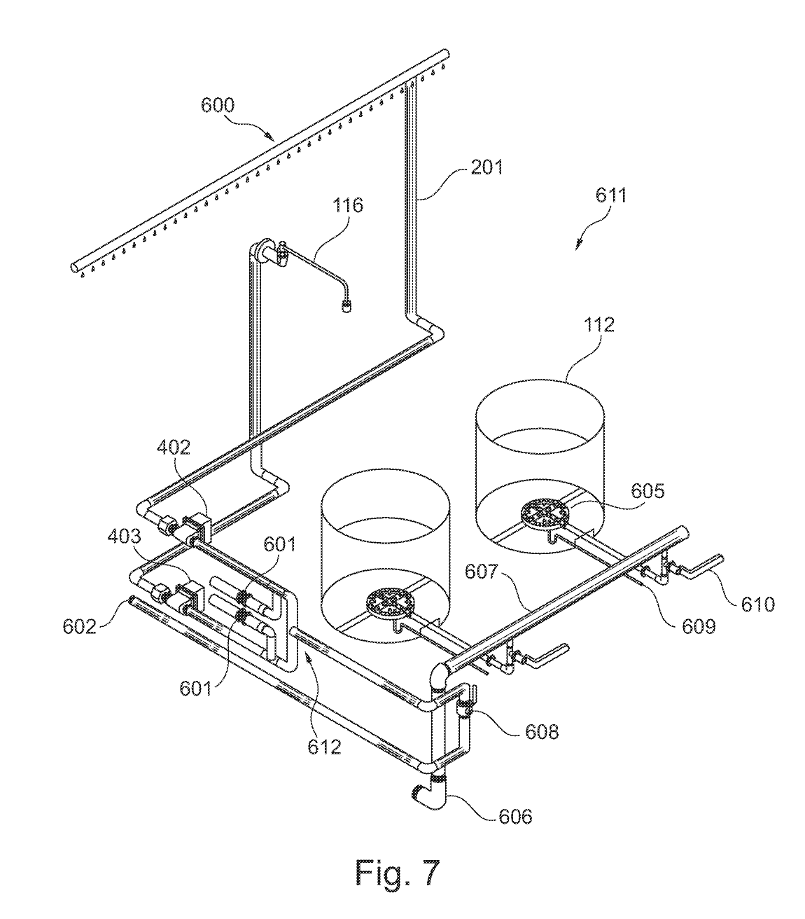

FIG. 7 presents a view of various cooling fluid and gas pipe components. Two gas wok burner assemblies 605 are partially enclosed by wok support structures 112. The wok support structures serve many important purposes such as focusing heat to the wok, protecting components from heat generated by the wok burner assemblies 605, supporting a wok and providing two circular interior wall structures to the intersecting surface cooling tank 300.

A gas adjustment lever 610 controls the amount of gas reaching the burner assembly and a pilot flame adjuster 609 controls the amount of gas used to fuel the pilot flame for each burner. A main water value 608 allows an operator to shut off the supply of tap water to the machine and a natural gas inlet 606 provides a connect point for a natural gas line.

With respect to the water lines, two water anti-hammer devices 601 are attached to water lines leading to the waterfall header 600 and water faucet 116. A water inlet 602 accepts tap water to supply the waterfall header and the water faucet. The waterfall sensor valve 402 is shown in connection with the waterfall header 600 and the faucet solenoid valve 403 is shown in connection with the faucet 116.

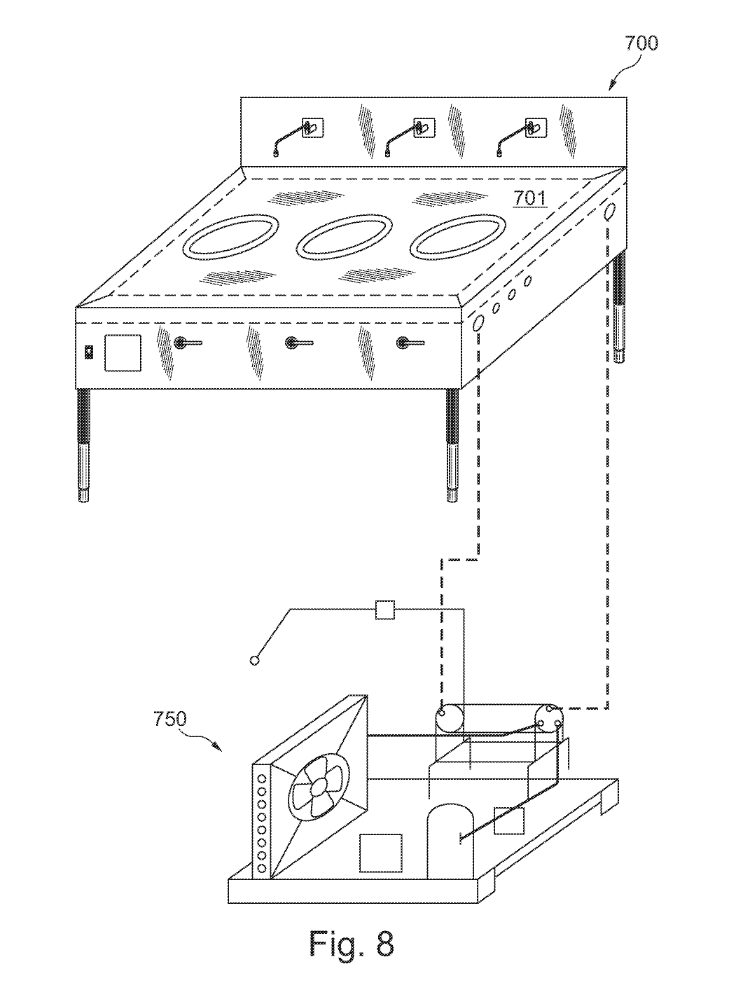

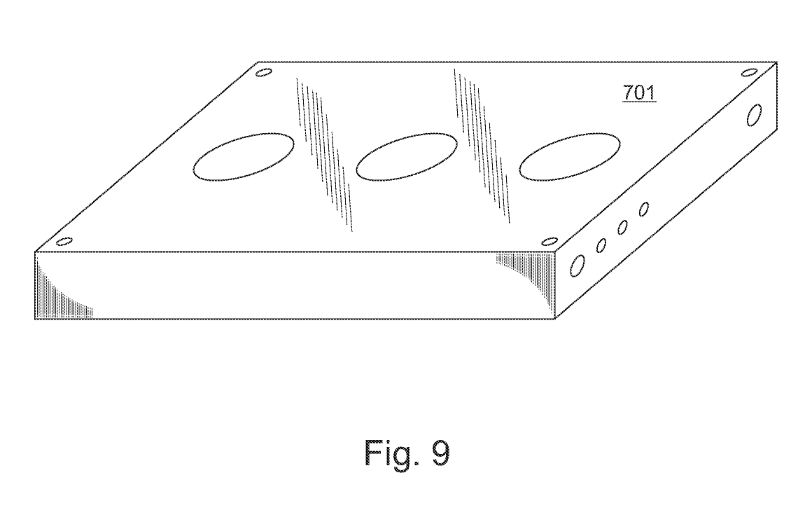

FIG. 8 shows an alternative retro-fit embodiment 700 with a table wok cooling tank 701 and a cooling unit 750 used for cooling fluid that circulates within the cooling tank. FIG. 9 is a perspective view of a table wok cooling tank.

The invention includes, but is not limited by the following items of novelty:

Item 1. A specialized machine for heating and supporting a wok, the machine comprising:

a) a circular wok support structure 112, constructed in the shape of a hollow cylinder, with a bottom end adjacent to a wok burner assembly 605 and a top end located above an upper deck plate 111;
b) the circular wok support structure rigidly connected to an interior section of the upper deck plate 111;
c) a surface cooling tank 300 using portions of the upper deck plate 111 as a top wall, having an angled front wall 301, a back wall 302, two side walls 303 and one or more interior circular walls comprising section from each circular wok support structure 112;
d) the surface cooling tank 300 connected to an inlet 202 with the inlet receiving chilled water or other fluid from a fluid cooling unit;
e) the surface cooling tank 300 connected to an outlet 203 with the outlet draining water circulated through the surface cooling tank 300 with the outlet leading the circulated fluid back to a fluid cooling unit;
f) a lower box assembly 400 with a top end attached to the upper deck plate 111, the lower box assembly having a thermo couple 401, a waterfall sensor valve 402, a faucet solenoid valve, a faucet water time control button 405, a voltage transformer, a waterfall safety thermostat 407;
g) a fluid and gas line assembly 611 connected to the lower box assembly 400, the fluid and gas line assembly comprising:
i. a wok burner assembly 605;
ii. a gas line attached to the wok burner assembly and to a gas header 607 with the gas header attached to a natural gas inlet 606;
iii. a tap water inlet 602 attached to a water pipe which in turn is attached to a waterfall and faucet junction 612, which in turn is connected to a waterline leading to a water faucet 116 and to a waterline leading to a water supply line 201 and waterfall header 600; with a waterfall sensor valve 402 located within the waterline leading to the waterfall header and a faucet solenoid valve 403 located within the waterline leading to the water faucet 116;
f) a waterfall backstop 110 connected to the top edge plate 111 with the waterfall backstop connected to the water faucet 116 and supporting a waterfall disperser component 114 with the waterfall disperser component attached to the waterfall header 600; and
g) an upper water collection pool area 117 attached to the angled front wall 301 of the surface cooling tank, with a mid-waterway 115 connected to the upper water collection pool area 117, and a lower waste drain 122 attached to the lower box assembly and positioned under the mid-waterway.

What is claimed is:

1. A specialized machine for heating and supporting a wok, the machine comprising:
a) a circular wok support structure, constructed in the shape of a hollow cylinder, with a bottom end adjacent to a wok burner assembly and a top end located above an upper deck plate;
b) the circular wok support structure rigidly connected to an interior section of the upper deck plate;
c) a surface cooling tank using portions of the upper deck plate as a top wall, having an angled front wall, a back wall, two side walls and one or more interior circular walls comprising section from each circular wok support structure;
d) the surface cooling tank connected to an inlet with the inlet receiving chilled water or other fluid from a fluid cooling unit;
e) the surface cooling tank connected to an outlet with the outlet draining water circulated through the surface cooling tank with the outlet leading the circulated fluid back to a fluid cooling unit;
f) a lower box assembly with a top end attached to the upper deck plate 111, the lower box assembly having a thermo couple, a waterfall sensor valve, a faucet solenoid valve, a faucet water time control button, a voltage transformer, a waterfall safety thermostat;
g) a fluid and gas line assembly connected to the lower box assembly, the fluid and gas line assembly comprising:
i. a wok burner assembly;
ii. a gas line attached to the wok burner assembly and to a gas header with the gas header attached to a natural gas inlet;
iii. a tap water inlet attached to a water pipe which in turn is attached to a waterfall and faucet junction, which in turn is connected to a waterline leading to a water faucet and to a waterline leading to a water supply line and waterfall header; with a waterfall sensor valve located within the waterline leading to the waterfall header and a faucet solenoid valve located within the waterline leading to the water faucet;
f) a waterfall backstop connected to the top edge plate with the waterfall backstop connected to the water faucet and supporting a waterfall disperser component with the waterfall disperser component attached to the waterfall header; and
g) an upper water collection pool area attached to the angled front wall of the surface cooling tank, with a mid-waterway connected to the upper water collection pool area, and a lower waste drain attached to the lower box assembly and positioned under the mid-waterway.
